(19) United States
(12) Patent Application Publication
(10) Pub. No.: US 2023/0068255 A1
(43) Pub. Date: Mar. 2, 2023

(54) MODELING, ANALYZING, AND CORRELATING USAGE PREFERENCES FOR TYPES OF CHECKOUTS

(71) Applicant: NCR Corporation, Atlanta, GA (US)

(72) Inventors: Itamar David Laserson, Givat Shmuel (IL); Karin Laloum, Tel-Aviv (IL); Norman Leonard Trujillo, Frisco, TX (US)

(21) Appl. No.: 17/460,534

(22) Filed: Aug. 30, 2021

(51) Int. Cl. G06Q 30/02; G06Q 20/20; G06Q 20/18; G06Q 40/00; G06F 16/28

(52) U.S. Cl. CPC G06Q 30/0201; G06Q 20/202; G06Q 20/18; G06Q 40/12; G06F 16/285; G06Q 20/209

(57) ABSTRACT

A checkout state for different types of transaction terminals of a store as a whole is determined during a given analyzed interval of time based on transaction logs for transactions processed during the interval. Each transaction is classified into a basket size based on that transaction's total number of items during the interval. Metrics are recorded for the checkout state by basket size and terminal type relative to the total number of transactions within the interval for all terminal types. Trends are derived from the metrics between adjacent analyzed intervals of time. The metrics and trends are custom provided by checkout state per basket size of each terminal type over configurable periods of time within graphs, charts, and tables rendered within a user interface.

### BACKGROUND

COVID19 accelerated the process of redesigning checkout locations in retail stores. Transitioning customers to Self-Checkouts (SCO) is leading the trend in this redesign effort with more retailers deploying SCOs in the wake of COVID19 to enforce social distancing and alleviate staff shortages. Even before COVID19, retailers were weighing the costs and benefits associated with transitioning more customers to SCOs and away from cashier-assisted checkouts. The retailers' concerns associated with SCO customer migration are associated with security deployed to thwart customer theft and associated with the extent to which customers would actually use SCOs.

Security can be addressed, through technology-based hardware and software solutions (more investment, e.g., more expense), for the first concern. But the second concern is more problematic because if customers do not adopt SCOs, then to retain the customers the retailers must ensure adequate staff is available to operate Point-Of-Sale (POS) terminals and all the expense associated with Self-Service Terminals (SSTs), needed for SCO technology, will have largely been a wasted investment.

Different conditions and circumstances during any given shopping journey of a customer often drives whether the customer will prefer a SCO or whether the customer will instead prefer cashier-assisted checkouts. As a result, simply deploying new or additional SSTs for SCOs usage does not work.

Consequently, retailers can invest too much in deploying SSTs and not experience any substantial long-term cost benefits that they expected. Generally, retailers are aware that customers prefer cashier-assisted checkouts when the customers have large baskets of items. When a customer has a large basket of items, a conventional SST has very small counter space (needed for scanning and bagging the customer's items) which makes the SCO challenging even for an adept customer who frequently uses an SST and who is familiar with the existing transaction interface of the SST.

Many other conditions (besides a customer's basket size) can dictate customer preferences for cashier-assisted checkouts or SCOs. Retailers are largely unaware of these conditions when they are being experienced and are further unaware to what extent the various conditions will drive customer usage of SSTs over time within their stores.

As a result, too few SSTs may be opened or closed at any given point in time for SCOs, too few Point-Of-Sale (POS) terminals may be opened or closed at any given point in time for cashier-assisted checkouts, a given retailer may be overstaffed or understaffed on any given day, and/or a given retailer may lack enough SSTs to satisfy customer demand/preference.

Thus, there is a need for retailers to have a better time-based and data-driven understanding of these conditions and their correlations to their customers' preferences in order to determine a proper investment level in SSTs, in order to determine a proper mix of open and closed SSTs and POS at any given point in time, and/or in order determine a proper staffing level for any given day/time of day.

### SUMMARY

In various embodiments, methods and a system for modeling, analyzing, and correlating usage preferences for types of checkouts are provided.

According to an embodiment, a method for correlating and reporting usage preferences for types of checkouts is presented. States of transaction terminal types as a whole are modeled within a preference model. Transaction logs are obtained during an interval from transaction terminals associated with the transaction terminal types. A current state of the transaction terminals as a whole is identified from the preference model based on analyzing transactions defined within the transaction logs. Each transaction for the interval is classified based on a basket size identified from the corresponding transaction log. Metrics are maintained for the current state by the corresponding basket size and by the corresponding transaction terminal type for the interval. The process iterates back to the transaction logs for a next interval. The metrics are rendered to an interface for a given period that comprises at least the interval and the next interval.

### BRIEF DESCRIPTION OF THE DRAWINGS

FIG. 1A is a diagram represent quadrants for customer preferences associated with Self-Checkouts (SCO) and cashier-assisted checkouts, according to an example embodiment.

FIG. 1B is a diagram of a system for modeling, analyzing, and correlating usage preferences for types of retail checkouts, according to an example embodiment.

FIG. 2 is a diagram of a method for correlating and reporting usage preferences for types of checkouts, according to an example embodiment.

FIG. 3 is a diagram of another method for correlating and reporting usage preferences for types of checkouts, according to an example embodiment.

### DETAILED DESCRIPTION

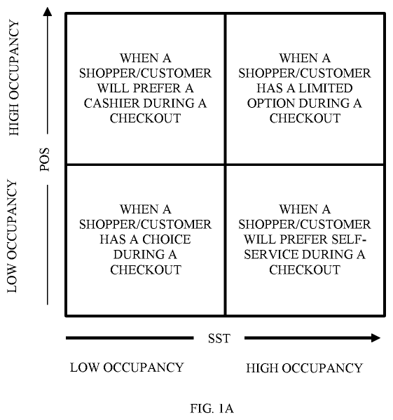

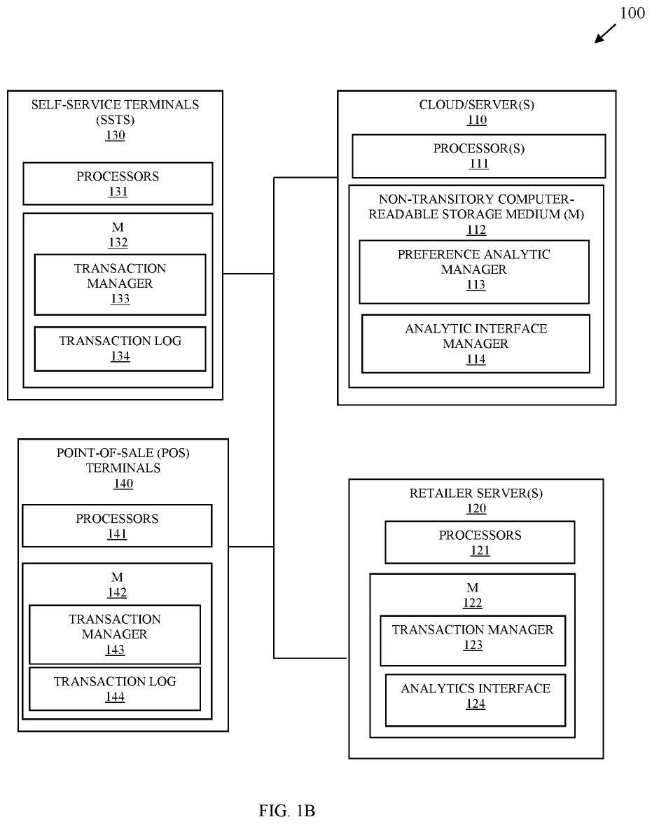

FIG. 1B is a diagram of a system/platform 100 for modeling, analyzing, and correlating usage preferences for types of retail checkouts, according to an example embodiment. It is to be noted that the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of modeling, analyzing, and correlating usage preferences for types of checkouts, presented herein and below.

System/platform 100 (herein after just “system 100”) provides a processing environment by which a given retailer can determine how successful SST adoption by its customer base is performing over time using detailed collected metrics associated with a states of POS terminals and SSTs, the store as a whole, and the basket sizes of the customers. The metrics can be presented in real-time via a retailer dashboard interface along with aggregated and real-time updated metrics over configured periods of time. System 100 analyzes the terminal states, basket sizes, and other conditions within the store to provide measures and metrics as to whether at any given point in time or periods of time customer SST adoption is achieving a retailer's expected goals or is falling short of expected goals, such that changes may be required by the retailer to get back on track with customer SST adoption. The metrics and analysis may also be interpreted in real time for the retailer to make decisions about opening more SSTs and/or opening and staffing more POS terminals to address current in-store conditions being experienced by the retailer.

A successful adoption of a retailer's SSTs for SCOs would expect to show an increased usage of SSTs over time, especially in transactions associated with small and medium-sized baskets. However, as stated above, other conditions/situations can alter when a customer uses a cashier-assisted checkout via a POS terminal besides just transaction basket size.

For example, when there is a significant difference between the total number of POS terminals open (manned by cashiers) and the total number of SST terminals open for SCOs and checkout traffic volume at a given store is high. These situations will generate a bias in traffic share between POS terminals for cashier-assisted transactions and SSTs for SCOs regardless of the customers actual preferences.

In another situation, there may be no POS terminals open for cashier-assisted checkouts and the only option for a customer is to go through an SST for a SCO. This type of situation is common late at night or early in the morning at a store.

In a reverse situation (of the last referenced situation), all the SSTs may be unavailable such that the customers can only go through POS terminal for cashier-assisted transactions. This type of situation can happen when there is no available staff to manage and assist customers at the SSTs or the SSTs are down due to some technical issues (e.g., software/interfaces are being upgraded, patched, maintenance, power outage, upgrading or swapping out peripheral devices, or other software and/or hardware related issues).

Furthermore, situations can occur where the checkout traffic is heavy at one of the checkout methods (SCO (via SSTs) or cashier-assisted (via POS terminals)) and low at the other available checkout method. This creates a bias for customers to select the checkout method that is experiencing the lower checkout traffic. For example, longer than normal queues (customer lines) at the POS terminal will naturally cause customers to migrate over to the SSTs, and when this occurs it is not a reliable indication that customers are adopting SCOs over cashier-assisted checkouts.

As stated above, customers, with larger baskets of items and/or many items that require lookup and weights (such as produce), have a known bias towards cashier-assisted checkouts.

If a retailer does not permit cash to be used as a method of payment at its SSTs (SSTs may lacks a valuable-media depository (currency acceptor and dispenser)), then cash-only customers are forced to checkout through the POS terminals with cashiers. Here, the retailers cannot assume that this is an indication that SCO migration is not as was expected by the retailer because the retailer is forcing cash-only customer to cashier-assisted checkouts.

Thus, retailers often make hasty and uninformed decisions about staffing for POS terminals and about their investment levels into SSTs (SCOs) because the retailers lack the data and metrics to fully appreciate the situations when they are occurring within their stores and to fully appreciate how frequently the situations properly correlate with their customer SST adoption over past periods of time within the retailer's store.

As is apparent, from the various situations/states of checkout traffic at opened POS terminals and at opened SSTs, any lack of SST adoption cannot simply be assumed based on actual recorded usage of the SSTs over time because many factors must be considered beyond just customer basket size and the percentage of customers using SSTs versus POS terminals. System/Platform 100 provides the analysis, metrics, and measures by which retailers can truly access their customer SCO migration expectations, progress, and needed investment levels.

Platform 100 provides analytics for customer preference for SCOs with objective insights (via in contextual metrics) that avoids or prevents bias.

As used herein, the terms “consumer,” “customer,” and/or “shopper” may be used interchangeably and synonymously.

Initially, a data model (shown in FIG. 1A) was derived that accounts for the situations or states of checkout terminals and provides an expectation of what objectively a given customer's preference should be for SCOs or cashier-assisted checkouts.

FIG. 1A is a diagram represent quadrants for customer preferences associated with Self-Checkouts (SCO) and cashier-assisted checkouts, according to an example embodiment.

FIG. 1A illustrates a 2×2 matrix that captures states of the two types of checkout terminals (POS terminal and SST) versus an expected customer preference for cashier-assisted and SCO checkouts. This data model is combined with the actual observed basket sizes of the customers for purposes of providing analytics and corresponding metrics that a given retailer can objectively rely upon for purposes of measuring how that retailer is performing in its customer SCO migration goal and for purposes of determining an appropriate investment level for that retailer's SSTs and related SCO technology.

System 100 comprises a cloud/server 110, one or more retailer servers 120, Self-Service Terminals (SSTs) 130, and Point-Of-Sale (POS) terminals 140.

Cloud/Server 110 comprises at least one processor 111 and a non-transitory computer-readable storage medium 112. Medium 112 comprises executable instructions for an image/video preference analytic manager 113 and analytic interface manager 114. The executable instructions when provided to and executed by processor 111 from medium 112 cause processor 111 to perform the processing discussed herein and below for preference analytic manager 113 and analytic interface manager 114.

Each retailer server 120 comprises at least one processor 121 and a non-transitory computer-readable storage medium 122. Medium 122 comprises executable instructions for a transaction manager 123 and an analytic interface 124. The executable instructions when provided to and executed by processor 121 from medium 122 cause processor 121 to perform the processing discussed herein and below for transaction manager 123 and analytics interface 124.

Each SST 130 comprises at least one processor 131 and a non-transitory computer-readable storage medium 132. Medium 132 comprises executable instructions for a transaction manager 133. The executable instructions when provided to and executed by processor 131 from medium 132 cause processor 131 to perform the processing discussed herein and below for transaction manager 133. Medium 132 also comprises a transaction log 134 that comprises transaction details for transactions, total number of transactions, total number of items per transaction, items per transaction, price of transaction, calendar date, time of day, etc.

Each POS terminal 140 comprises at least one processor 141 and a non-transitory computer-readable storage medium 142. Medium 142 comprises executable instructions for a transaction manager 143. The executable instructions when provided to and executed by processor 141 from medium 142 cause processor 141 to perform the processing discussed herein and below for order app/interface 143. Medium 142 also comprises a transaction log 144 (as discussed above with the SST 130).

It is to be noted that transaction logs 134 and 144 may also be stored on the corresponding retailer server 120, such that preference analytic manager 113 receives or obtains transaction logs 134 and 144 from SST 130, POS terminal 140, and/or retailer server 120.

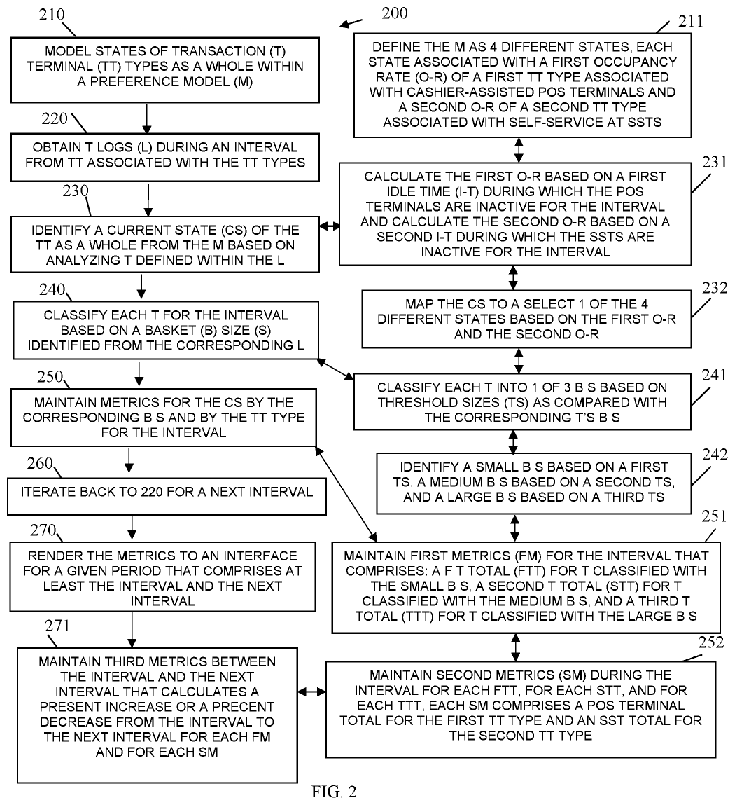

Transaction logs 134 and 144 are analyzed by preference analytic manager 113 in view of the 2×2 preference model (FIG. 2A) and in view of the basket sizes (total number of purchased items) of each transaction. Low and high occupancy for the SSTs 130 and POS terminals 140 is calculated by preference analytical manager 113 as a percentage of idle time (no transaction activity being reported) at each of the terminals 130 and 140 in any given configured interval or time.

Preference analytic manager 113 also identifies a total number of SSTs 130 available during a given configured interval of time as well as a total number of POS terminals 140 available during the interval of time. So, the total number of available SSTs 130 to handle transactions for SCOs, the occupancy percentage for SSTs 130, the total number of available POS terminals 140, and the occupancy percentage for POS terminals 140 are calculated during any given interval of time by preference analytic manager 113. The transaction logs 134 and 144 comprise the basket sizes of each transaction during any given interval of time that is being evaluated, such that each transaction processed on either an SST 130 or a POS terminal 140 can be determined to be a small or large basket size.

A variety of configured thresholds may be used by preference analytic manager 133 for purposes of determining what is to be considered an average terminal occupancy rate, a low terminal occupancy rate, and a high terminal occupancy rate per terminal type (SST 130 or 140). Another set of thresholds can identify what is considered to be a high number of items in a given basket, an average number of items in the given basket, and a low number of items in the given basket.

The preference analytic manager 113 can process historical transaction log data 134 and 144 for a given interval of time for purposes of establishing metrics for periods of time. The preference analytic manager 113 can also process in real time for purposes of providing a current view of a given retail store within a current ongoing interval of time. As each interval of time is processed, the aggregated metrics accumulated before the current interval concludes are updated.

During each interval of time being evaluated by preference analytic manager 113, preference analytic manager 113 determines a state of the terminals 130 and 140 that maps to the preference model of FIG. 1A. For example, the bottom left quadrant represents a first state of the checkout terminals 130 and 140 “when a shopper/customer has a choice during checkout,” since analytic manager 113 determines there is low occupancy (traffic) on the SSTs 130 and the POS terminals 140. This is an important state for which a retailer can analyze to determine how well the retailer is doing in migrating customers to SCOs via the SSTs 130 especially for transactions having small basket sizes because it identifies those customers that are actively choosing to use the SST 130 or identifies those customers that are actively not choosing to use SST 130 and instead are using POS terminals 140 for cashier-assisted checkouts.

A second stated identified from the preference model of FIG. 1A (top upper left quadrant) represents a situation when there is actually low traffic (low occupancy) at the SSTs 140 but high traffic (high occupancy) at the POS terminals 140 but the customer still prefers a cashier in a cashier-assisted transaction at the POS terminals 140. This may be reasonable if a given customer has a large basket (high number of items and/or items that need identified and weighed) but is problematic when a given customer has a small basket of items (low number of items).

A third state identified from the preference model of FIG. 1A (bottom right quadrant) represents a situation when there is high traffic at the SSTs 130 and low traffic at the POS terminals 140 but the customer still prefers to perform SCOs via the SSTs 130. This is a situation where the customers performing under this situation (third state) is an ideal customer to the retailer, especially when such a customer has an average size or large size basket of items because this is a condition that the retailer would like to achieve with most of its customers in order to move to an ideal SCO environment.

A fourth state identified from the preference model of FIG. 1A (top right quadrant) represents a situation when the customer has limited options because both the POS terminals 140 and the SST 130 have long queues and the customer's wait times are long. This state when combined with the opened POS terminals 140 and opened SSTs 130 may also be used to identify that more lanes (SCO and cashier-assisted) need or needed to be opened for customer during the current interval or time or during the interval of time being reported.

Each state identified during an evaluated interval of time/period of time from the preference model FIG. 1A when combined with metrics for the corresponding total number of transactions by basket size (i.e., period P, state S, basket size N=x % of all transactions for period P) provides invaluable objective insights to the retailer about its customer base and its customers willingness to migrate to SCOs over cashier-assisted transactions. The metrics can be aggregated over different periods, such as by week, by month, by quarter, by season, by year. The metrics can be visualized through graphs over the different periods of time. Trends can be derived through statistical analysis to show migration to SCOs is increasing or decreasing by a certain percentage over the periods or from period to period.

Analytics manager 113 maintains the metrics in real time and over time in a data store as well as derived statistical trends. Analytic interface manager 114 renders reports through analytics interface 124 using the metrics of the data store. Interface manager 114 can provide a variety of graphs, tables, charts, and/or interactive graphs. For example, a graph may be provided per state (4 different graphs) over time that visually illustrates (plots by unique color and line) by basket size (large, medium, small) the trendline for each basket size. Each trendline includes a plotted % of the transactions for the basket size that were performed via SSTs 130 for the given state and during that interval or time for the period as a whole. The retailer can set the period for the report (such as last 6 months). A table can be presented for the period showing the aggregated totals by state based on available SST hours, available POS terminal hours, and percentages of total available store hours in each state (as identified in the preference model of FIG. 1A and discussed above). A summary table can be generated and provided by interface manager 114 through interface 124 in a report, that lists for each state during a given user defined period the total number of transactions (baskets) by basket size (small, medium, large), the percentage of total of the transactions for the corresponding basket size that were performed at the SST 130, performed at the POS 140, a short term trend (month over month) percentage up or down from a prior reporting period, and a long term trend (quarter over quarter) from a prior reporting period.

Interface manager 114 may also render a dashboard through interface 124 that is updated in real time as analytic manager 113 receives real time data and updates the data store with the metrics for a current interval of time during which real time transaction logs 134 and 144 are being analyzed by analytic manager 113. The dashboard may render the current real-time metrics for the store along with a current state being experienced by the store and a total number of SSTs 130 open, a total number of POS terminals 140 open, a total number of unused SSTs 130, a total number of unmanned POS terminals 140. A retailer may quickly determine that the more SSTs 130 need to be opened or that more POS terminals 140 need to be staffed for opening or that both should be done (more SSTs 130 and more POS terminals 140). The user may click on options or the dashboard itself and receive a real-time updated summary for a user-defined period of time for each state (the 4 states discussed above and illustrated in the preference model of FIG. 1A). The summary may include the table summary for the period and the trends per state, the graphs per state (each state graph illustrating the trend lines by basket size (3 separate trendlines for small baskets, medium baskets, and large baskets)), terminal type hours of availability totals, a table showing what percent each basket size was vis-a-vis the total transactions as a whole (e.g., 53% of the total number of baskets (transactions) were small, etc.).

Furthermore, the metrics may be maintained by analytic manager 114 for multiple stores of the retailer and interface manager 114 can render a bar chart to the retailer through interface 124 for all the stores plotted within the single bar chart. The bar chart illustrates the percentage of total small basket transactions at each store that were performed via an SST 130 (a SCO) along with an average percentage of small baskets performed on an SST 130 for each of the retailers' stores plotted on a line across the stores within the bar chart. The retailer can click on any given store and receive the summary tables, graphs, and totals by state for any given period of time. In this way, interactive graphs and charts can be rendered within interface 124 that when interacted with aggregate summary graphs and details are presented or coarse-grain level details are presented to the retailer. The level of detail of supporting metrics is controlled through user interaction with the rendered chart, graph, and/or table.

Preference analytic manager 113 analyzes the transaction logs 134 and 144 for a given store during a given interval of time (can be real time and/or a historical time period). Transactions (baskets) are classified during the interval as being small baskets, medium or average-sized baskets, or large baskets (based on the total number of items in each transaction and based on configured thresholds for small, medium, and large). The state for the interval is determined (based on the occupancy rate calculated as idle time) of each opened SST 130 and each opened POS terminal 140 during the interval. The state corresponds to one of the quadrants identified in the preference model of FIG. 1A (4 states or 4 quadrants). The percentage of each small, medium, and large basket during the interval for all the baskets (transactions) of the interval is tabulated as metrics housed in a data store for the store, the interval, and the state. Analytic manager 113 determines the rate/percentage of change between intervals over periods of time as trends and continuously updates the trends and metrics as new intervals are classified into a state and the baskets are analyzed for the store. Interface manager 114 uses the metrics and trends derived by analytic manager 113 to generate summaries per store or across multiple stores for a given retailer, and the metrics and trends are reported in a variety of graphs, interactive graphs, charts, tables, etc., which are provided to a retailer through an interface screens and/or dashboards through analytics interface 124.

System 100 provides a data preference model (FIG. 1A) that illustrates 4 states or 4 quadrants that are analyzed via transaction logs 134 and 144 per basket size for providing a variety of custom reports and/or dashboards to the retailer via interface 124. The retailer can use this information contained in the reports and dashboard to make real-time changes to staffing to man POS terminals 140, to open up more SSTs 130, and/or to determine whether customer education and/or marketing should be deployed to improve customer SCO adoption. In some cases, customers of the retailer that appear to have fully adopted SCOs can be analyzed and/or surveyed for purposes of discovering how to get other customers to move towards SCOs. The information can also be used to justify more investment in SSTs 130 and SCO technology. Furthermore, problems associated with customer SCO adoption can be more easily isolated and identified with the reports and/or dashboard. For example, problems may be addressed through improved transaction interfaces to transaction manager 133 of the SST 130, improved processing throughput of transaction manager 133, integration of computer-vision and assistance to transaction manager 133, etc.

In an embodiment, analytic manager 113 and interface manager 114 may be provided to a given retailer via analytics interface 124 as Software-as-a-Service (SaaS).

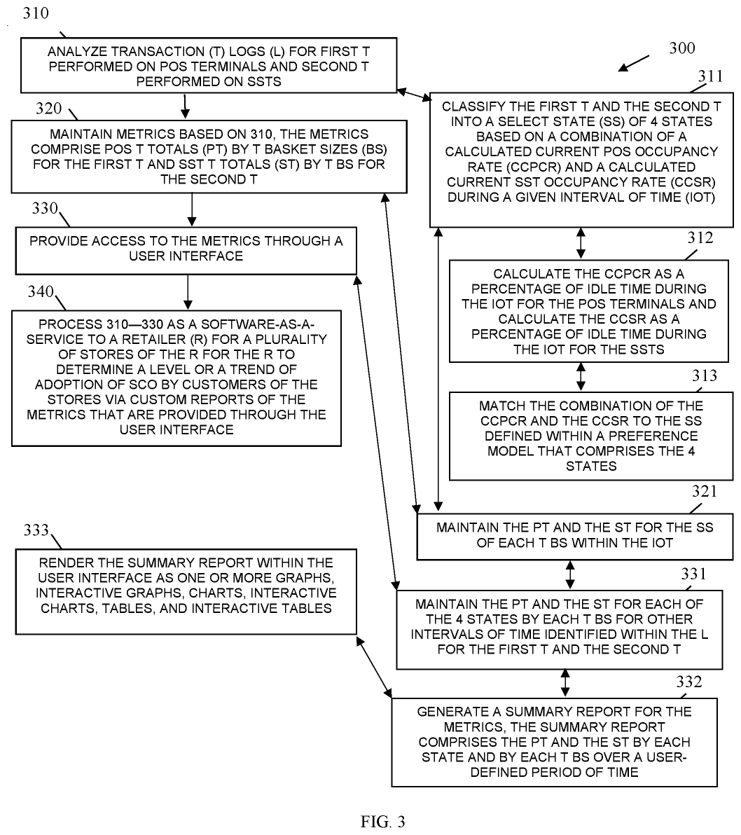

The above-referenced embodiments and other embodiments are now discussed within FIGS. 2-3.

FIG. 2 is a diagram of a method 200 for correlating and reporting usage preferences for types of checkouts, according to an example embodiment. The software module(s) that implements the method 200 is referred to as a “self-checkout analytic service.” The self-checkout analytic service is implemented as executable instructions programmed and residing within memory and/or a non-transitory computer-readable (processor-readable) storage medium and executed by one or more processors of one or more devices. The processor(s) of the device that executes the self-checkout analytic service are specifically configured and programmed to process the self-checkout analytic service. The self-checkout analytic service may have access to one or more network connections during its processing. The network connections can be wired, wireless, or a combination of wired and wireless.

In an embodiment, the device that executes the self-checkout analytic service is cloud 110. Cloud 110 comprises a plurality of servers logically cooperating and accessible as a single server 110 (cloud 110).

In an embodiment, the device that executes the self-checkout analytic service is a server 110 that is separate from any given retailer server 120. In an embodiment server 110 is subsumed and operates on a specific retailer server 120.

In an embodiment, the self-checkout analytic service is all or some combination of 113, 114, and/or 124.

At 210, the self-checkout analytic service models states of transaction terminal types as a whole within a preference model. In an embodiment, the preference model is the model illustrated in FIG. 1A.

In an embodiment, at 211, the self-checkout analytic service defines the preference model as 4 different states (quadrants), each state associated with a first occupancy rate for a first transaction terminal type associated with cashier-assisted POS terminals and a second occupancy rate of a second transaction terminal type associated with self-service at SSTs.

At 220, the self-checkout analytic service obtains transaction logs 134 and 144 during an interval of time from transaction terminals 130 and 140 associated with the transaction terminal types (POS terminal type and SST type)

At 230, the self-checkout analytic service identifies a current state of the transaction terminals as a whole from the preference model based on analyzing the transactions defined within the transaction logs 134 and 144.

In an embodiment of 211 and 230, at 231, the self-checkout analytic service calculates the first occupancy rate based on a first idle time during which the POS terminals 140 are inactive/idle for the interval. The self-checkout analytic service also calculates a second occupancy rate based on a second idle time during which the SSTs 130 are inactive/idle for the interval.

In an embodiment of 231 and at 232, the self-checkout analytic service maps the current state to a select 1 of 4 different states based on a combination of both the first occupancy rate and the second occupancy rate.

At 240, the self-checkout analytic service classifies each transaction for the interval based on a basket size (total number of items within a given transaction) identified from the corresponding transaction log 134 or 144.

In an embodiment of 231 and 240, at 241, the self-checkout analytic service classifies each transaction into 1 of 3 basket sizes based on threshold sizes as compared with the corresponding transaction's actual basket size.

In an embodiment of 241 and at 242, the self-checkout analytic service identifies a small basket size based on a first threshold size, a medium basket size based on a second threshold size, and a large basket size based on a third threshold size.

At 250, the self-checkout analytic service maintains metrics for the current state by the corresponding basket size and by the transaction terminal type for the interval.

In an embodiment of 242 and 250, at 251, the self-checkout analytic service maintains first metrics for the interval that comprises a first transaction total for transactions classified with the small basket size, a second transaction total for transactions classified with the medium basket size, and a third transaction total for transactions classified with the large basket size.

In an embodiment of 251 and at 252, the self-checkout analytic service maintains second metrics during the interval for each first transaction total, for each second transaction total, and for each third transaction total, each second metric comprises a POS terminal total for the first transaction terminal type and an SST total for the second transaction terminal types.

At 260, the self-checkout analytic service iterates back to 220 for a next interval of time available in the transaction logs.

At 270, the self-checkout analytic service renders the metrics within an interface 124 for a given period of time that comprises at least the interval and the next interval of time.

In an embodiment of 252 and 270, at 271, the self-checkout analytic service maintains third metrics between the interval and the next interval that calculates a percent increase or a percent decrease from the interval to the next interval for each first metric and for each second metric. This is the rate of change between intervals and is reflective of a trends from interval to interval.

FIG. 3 is a diagram of another method 300 for correlating and reporting usage preferences for types of checkouts, according to an example embodiment. The software module(s) that implements the method 300 is referred to as a “transaction type monitor and analytic service.” The transaction type monitor and analytic service is implemented as executable instructions programmed and residing within memory and/or a non-transitory computer-readable (processor-readable) storage medium and executed by one or more processors of a device. The processors that execute the transaction type monitor and analytic service are specifically configured and programmed for processing the transaction type monitor and analytic service. The transaction type monitor and analytic service may have access to one or more network connections during its processing. The network connections can be wired, wireless, or a combination of wired and wireless.

In an embodiment, the device that executes the transaction type monitor and analytic service is cloud 110. In an embodiment, the device that executes the transaction type monitor and analytic service is server 110. In an embodiment, server 110 is subsumed into and operates from a specific retailer server 120.

In an embodiment, the transaction type monitor and analytic service is all of or some combination of 113, 114, 125, and/or method 200 of FIG. 2.

The transaction type monitor and analytic service presents another and, in some ways, enhanced processing perspective from that which was discussed above for cloud 110 and method 200.

At 310, the transaction type monitor and analytic service analyzes transaction logs 134 and 144 for first transaction performed on POS terminals 140 and second transactions performed on SSTs 130.

In an embodiment, at 311, the transaction type monitor and analytic service classifies the first transactions and the second transactions into a select state of 4 available states based on a combination of a calculated current POS occupancy rate and a calculated current SST occupancy rate during any given interval of time defined within the transaction logs 134 and 144 based on date and time stamps associated with the first transactions and the second transactions.

In an embodiment of 311 and at 312, the transaction type monitor and analytic service calculates the calculated current POS occupancy rate as a percentage of idle time for the POS terminals 140 during the given interval of time and calculates the calculated current SST occupancy rate as a percentage of idle time for the SSTs 130 during the given interval of time.

In an embodiment of 312 and at 313, the transaction type monitor and analytic service matches the combination of the calculated current POS occupancy rate and the calculated current SST occupancy rate to the select state defined within a preference model that comprises the four states (e.g., 4 quadrants defined by the preference model illustrated and discussed with FIG. 1A above).

At 320, the transaction type monitor and analytic service maintains metrics based on 310. The metrics comprise POS transaction totals by transaction basket sizes for the first transactions and SST transaction totals by the transaction basket sizes for the second transactions.

In an embodiment of 311 and 320, at 321, the transaction type monitor and analytic service maintains the POS transaction totals and the SST transaction totals for the select state of each transaction basket size within the interval of time.

At 330, the transaction type monitor and analytic service provides access to the metrics through a user interface 124.

In an embodiment of 321 and 330, at 331, the transaction type monitor and analytic service maintains the POS transaction totals and the SST transaction totals for each of the 4 available states by each transaction basket size for other intervals of time identified within the transaction logs for the first transactions and the second transactions.

In an embodiment of 331 and at 332, the transaction type monitor and analytic service generates a summary report for the metrics. The summary report comprises the POS transaction totals, and the SST transaction totals by each state and by each transaction basket size over a user-defined period of time. The user-defined period of time provided by a user operating interface 124.

In an embodiment of 332 and at 333, the transaction type monitor and analytic service renders the summary report within the user interface 124 as one or more graphs, interactive graphs, charts, interactive charts, tables, and interactive tables.

In an embodiment, at 340, the transaction type monitor and analytic service is processed as a SaaS to a retailer for a plurality of the retailer's stores. The reports and alerts provided from the metrics through the interface 124 permit the retailer to determine a level or a trend of adoption of SCOs by customers of the stores.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
modeling states of transaction terminal types as a whole within a preference model;
obtaining transaction logs during an interval from transaction terminals associated with the transaction terminal types;
identifying a current state of the transaction terminals as a whole from the preference model based on analyzing transactions defined within the transaction logs;
classifying each transaction for the interval based on a basket size identified from the corresponding transaction log;
maintaining metrics for the current state by the corresponding basket size and by the corresponding transaction terminal type for the interval;
iterating back to the obtaining for a next interval; and
rendering the metrics to an interface for a given period that comprises at least the interval and the next interval.

2. The method of claim 1, wherein modeling further includes defining the preference model as four different states, each state associated with first occupancy rate of a first transaction terminal type associated with cashier-assisted Point-Of-Sale (POS) terminals and a second occupancy rate of a second transaction terminal type associated with self-service at Self-Service Terminals (SSTs).

3. The method of claim 3, wherein identifying further includes calculating the first occupancy rate based on a first idle time during which the POS terminals are inactive for the interval and calculating the second occupancy rate based on a second idle time during which the SSTs are inactive for the interval.

4. The method of claim 3, wherein calculating further includes mapping the current state to a select one of the four different states based on the first occupancy rate and the second occupancy rate.

5. The method of claim 4, wherein classifying further includes classifying each transaction into one of three basket sizes based on threshold sizes as compared with the corresponding transaction's basket size.

6. The method of claim 5, wherein classifying further includes identifying a small basket size based on a first threshold size, a medium basket size based on a second threshold size, and a large basket size based on a third threshold size.

7. The method of claim 6, wherein maintaining further includes maintaining first metrics for the interval that comprises: a first transaction total for transactions classified with the small basket size, a second transaction total for transactions classified with the medium basket size, and a third transaction total for transactions classified with the large basket size.

8. The method of claim 7, wherein maintaining further includes maintaining second metrics during the interval, for each first transaction total, for each second transaction total, and for each third transaction total, each second metric comprises a POS terminal total for the first transaction terminal type and an SST total for the second transaction terminal type.

9. The method of claim 8 further comprising, maintaining third metrics between the interval and the next interval that calculates a percent increase or a percent decrease from the interval to the next interval for each of the first metrics and for each of the second metrics.

10. A method, comprising:
analyzing transaction logs for first transactions performed on Point-of-Sale (POS) terminals and for second transactions performed on Self-Service Terminals (SSTs);
maintaining metrics based on the analyzing, the metrics comprising POS transaction totals by transaction basket sizes for the first transactions and SST transaction totals by the transaction basket sizes for the second transactions; and
providing access to the metrics via a user interface.

11. The method of claim 10, wherein analyzing further includes classifying the first transactions and the second transactions into a select state of four states based on a combination of a calculated current POS occupancy rate and a calculated current SST occupancy rate during a given interval of time.

12. The method of claim 11, wherein classifying further includes calculating the calculated current POS occupancy rate as a percentage of POS idle time during the given interval of time for the POS terminals and calculating the calculated current SST occupancy rate as a percentage of SST idle time during the given interval of time for the SSTs.

13. The method of claim 12, wherein calculating further includes matching the combination of the calculated current POS occupancy rate and the calculated current SST occupancy rate to the select state defined within a preference model that comprises the four states.

14. The method of claim 11, wherein maintaining further includes maintaining the POS transaction totals and the SST transaction totals for the select state of each transaction basket size within the given interval of time.

15. The method of claim 14, wherein maintaining further includes maintaining the POS transaction totals and the SST transaction totals for each of the four states by each transaction basket size for other intervals of time identified within the transaction logs for the first transactions and the second transactions.

16. The method of claim 15, wherein providing further includes generating a summary report from the metrics, the summary report comprises the POS transaction totals, and the SST transaction totals by each state and by each transaction basket size over a user-defined period of time.

17. The method of claim 16, wherein generating further includes rendering the summary report within the user interface as one or more graphs, interactive graphs, charts, interactive charts, tables, and interactive tables.

18. The method of claim 10 further comprising, processing the method as a Software-as-a-Service (SaaS) to a retailer for a plurality of stores of the retailer for the retailer to determine a level or a trend of adoption of self-checkouts by customers of the stores via custom reports of the metrics that are provided through the user interface.

19. A system, comprising:
a cloud processing environment comprising at least one server;
the at least one server comprising a processor and a non-transitory computer-readable storage medium;
the non-transitory computer-readable storage medium comprises executable instructions; and
the executable instructions when executed on the processor from the non-transitory computer-readable storage medium cause the processor to perform operations comprising:
analyzing transaction logs for first transaction performed on Point-Of-Sale (POS) terminals and second transactions performed on Self-Service Terminals (SSTs);
for each interval of time defined within the transaction logs:
calculating a first percentage of idle time for the POS terminals;
calculating a second percentage of idle time for the SSTs;
matching a combination of the first percentage and the second percentage to a current state defined in a preference model;
tabulating POS transaction totals by transaction basket sizes for the first transactions;
tabulating SST transaction totals by the transaction basket sizes for the second transactions;
storing the POS transaction totals for the current state by the transaction basket sizes as first metrics within a data store; and
storing the SST transaction totals for the current state by the transaction basket sizes as second metrics within the data store;
calculating an increase percentage or a decrease percentage for each of the first metrics and each of the second metrics for a previous interval of time; and
storing the third metrics within the data store;
providing a user-interface for receiving and defining custom reports and interactive visually distinctive graphics from the first metrics, the second metrics, and the third metrics of the data store over a given period of time.

20. The system of claim 19, wherein the executable instructions when executed on the processor from the non-transitory computer-readable storage medium further cause the processor to perform additional operations comprising:
rendering within the interface a dashboard that presents summary details for select first metrics, select second metrics, and select third metrics that are being updated in real time as additional first transactions and additional second transactions are detected and analyzed from the transaction logs.
